(19) United States
(12) Patent Application Publication
(10) Pub. No.: US 2004/0085276 A1
(43) Pub. Date: May 6, 2004

(54) Method for adjusting brightness level of display

(75) Inventor: Yang Hoon Kim, Sungnam-si (KR)

Correspondence Address: FLESHNER & KIM, LLP, P.O. BOX 221200, CHANTILLY, VA, 20153, US

(73) Assignee: LG Electronics Inc.

(21) Appl. No.: 10/695,753

(22) Filed: Oct. 30, 2003

(30) Foreign Application Priority Data
Oct. 31, 2002 (KR) 66829/2002

(51) Int. Cl. G09G 3/36

(52) U.S. Cl. 345/87

(57) ABSTRACT

Methods and apparatus for adjusting the brightness level of a display (LCD) can separately store index information corresponding to each brightness level of the LCD according to which of a plurality of types of power are being used. Further, when the type of power of the system is changed, the index information corresponding to the power being used (e.g., changed power) is preferably read in order to adjust the brightness level of the LCD. Therefore, it is possible to maintain a preadjusted brightness level of the LCD by a user in a corresponding power mode.

### BACKGROUND OF THE INVENTION

1. Field of the Invention

The present invention relates to a display and method of operating the same, and in particular, a method and apparatus for adjusting the brightness level of a liquid crystal display used in a computer.

2. Discussion of the Background Art

FIG. 1 is a block diagram illustrating the overall organization of a related art portable personal computer including a liquid crystal display (LCD). As shown in FIG. 1, power from an inverter is applied to the LCD through an inverter cable under control of a microcomputer (micom).

LCDs come in diverse kinds and sizes, and each one has its own optical characteristics. In case of a LCD using a light-emitting element, for example, a CCFL (Cold Cathode Fluorescent Lamp) disposed at an upper or lower side of the LCD, the brightness of the LCD is adjusted by illuminating the CCFL using a high voltage being applied via the inverter.

FIG. 2 is a block diagram illustrating the organization of a related art portable personal computer. For instance, a notebook computer includes a CPU 10, a video controller 11, Host-PCI Bridge 12, a memory 13, video RAM 14, an audio controller 15, a LAN controller 16, a Card BDS controller 17, PCI-ISA Bridge 18, a LCD 19, micom 20, and a keyboard 21, each being connected through a bus (line). The PCI-ISA Bridge 18 includes CMOS-RAM 180, and the micom 20 includes ROM 200, RAM 201, and a keyboard controller 203.

As described above, the related art display has various disadvantages. The related art displays in portable computers or the like have a display brightness that is not controlled for a variety of power sources. Accordingly, a set-brightness level of the display is not maintained, for example, during power on/off.

The above references are incorporated by reference herein where appropriate for appropriate teachings of additional or alternative details, features and/or technical background.

### SUMMARY OF THE INVENTION

An object of the invention is to solve at least related art problems and/or disadvantages and to provide at least the advantages described hereinafter.

Another object of the present invention is to solve at least disadvantages of the related art by providing a method and apparatus for adjusting the brightness level of a display that uses information corresponding to each brightness level of the display in at least two power modes.

Another object of the present invention is to provide a method and apparatus that adjusts a brightness level of a display by storing index information corresponding to a brightness level of the display for at least two power modes and when system power mode is changed and/or the system is re-started, reading information on power currently being used.

Another object of the present invention is to provide a method and apparatus that adjusts a brightness level of a display so that when a power mode is changed, for example to a battery power, information corresponding to the brightness level corresponding in the battery power mode is used to adjust the LCD brightness level.

Another object is to provide a method and apparatus for adjusting a brightness level of an LCD used in a portable personal computer such as a notebook computer that allows a user to maintain a preadjusted LCD brightness level in an AC adaptor power mode and in a battery power mode, respectively, by independently storing index information corresponding to each brightness level of the LCD in different power modes, and by reading index information corresponding to a power that has been preset or used by the user when the system power of the portable personal computer is turned on or the power of the computer system is switched.

To achieve at least these objects and other advantages in a whole or in part and in accordance with the purpose of the invention, as embodied and broadly described herein, there is provided a method for adjusting a brightness level of a display used in a portable computer system that includes separately providing brightness control information for a plurality of brightness levels for each of at least two power mode types, confirming a type of power mode currently being used out of said at least two power mode types and controlling the brightness level of the display by using corresponding brightness control information on the confirmed power mode.

To further achieve at least these objects and other advantages in a whole or in part and in accordance with the purpose of the invention, as embodied and broadly described herein, there is provided a method that includes determining a type of power supply currently being used among a plurality of power supplies in a computer system when a brightness level of a display is adjusted, selecting a brightness level information corresponding to the determined power supply type among brightness level information of the adjusted brightness level of the display for each of the plurality of power supplies and reading an index information corresponding to the selected brightness level information and driving the adjusted brightness level of the display based on the readout index information, and independently storing the index information according to the type of power supply.

To further achieve at least these objects and other advantages in a whole or in part and in accordance with the purpose of the invention, as embodied and broadly described herein, there is provided a method for adjusting a brightness level of a display that includes independently storing index information corresponding a brightness level of the display in at least two different power modes and adjusting a brightness of the display using information on a current power mode being used and the stored index information for the brightness level of the current power mode when the power mode is changed.

To further achieve at least these objects and other advantages in a whole or in part and in accordance with the purpose of the invention, as embodied and broadly described herein, there is provided an apparatus that controls an inverter pulse width modulation (PWM frequency of a liquid crystal display (LCD) in a portable computer that includes a storage device configured to separately provide LCD brightness level information for a plurality of brightness levels for each of at least two power mode types, an inverter configured to supply a voltage to the LCD and control means for controlling a PWM frequency of the inverter in accordance with a designated brightness level, a current power supply mode and the corresponding LCD brightness level information for the current power supply mode.

Additional advantages, objects, and features of the invention will be set forth in part in the description which follows and in part will become apparent to those having ordinary skill in the art upon examination of the following or may be learned from practice of the invention. The objects and advantages of the invention may be realized and attained as particularly pointed out in the appended claims.

### BRIEF DESCRIPTION OF THE DRAWINGS

The invention will be described in detail with reference to the following drawings in which like reference numerals refer to like elements wherein:

FIG. 1 is a block diagram illustrating the overall organization of a related art portable personal computer including a liquid crystal display (LCD);

FIG. 2 is a block diagram illustrating the organization of a related art portable personal computer;

FIG. 3 is a block diagram illustrating the organization of a related art LCD brightness level adjusting apparatus used in a portable personal computer;

FIG. 4 is a diagram illustrating LCD brightness control information that is stored and managed in a related art portable personal computer;

FIG. 5 is a diagram illustrating a preferred embodiment of a display brightness control information that can be stored and managed in a portable personal computer according to the present invention;

FIG. 6 and FIG. 7 are flow charts showing preferred embodiments of a method for adjusting the brightness level of a LCD in a portable personal computer, respectively, according to the present invention;

FIG. 8 is a flow chart showing a preferred embodiment of a method for controlling the brightness level of a LCD according to the present invention; and

FIG. 9 is a flow chart showing a preferred embodiment of a brightness control method responsive to the change of power being used according to the present invention.

### DETAILED DESCRIPTION OF PREFERRED EMBODIMENTS

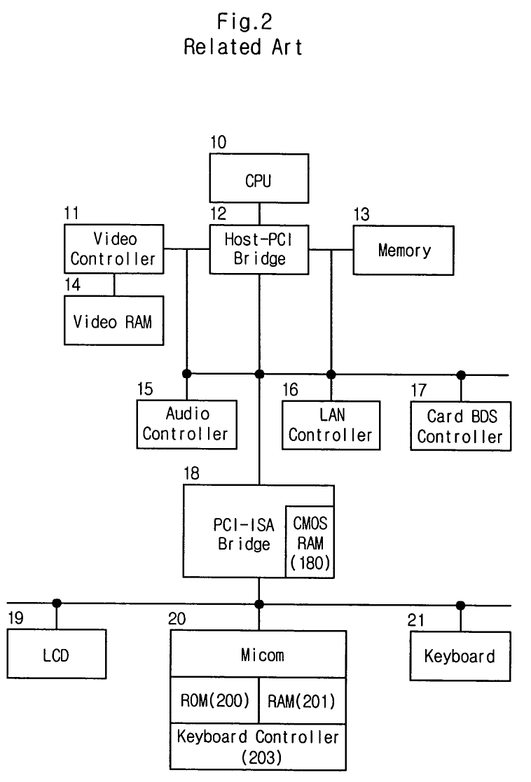

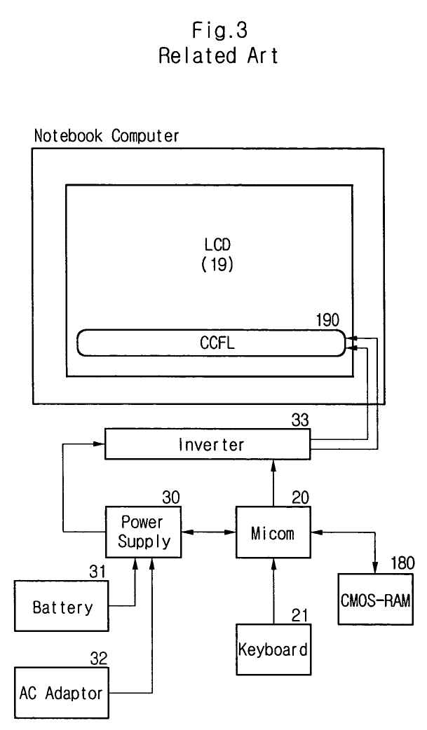

FIG. 3 is a block diagram illustrating the organization of a related art LCD brightness level adjusting apparatus used in a portable personal computer. The related art LCD brightness level adjusting apparatus will be described with reference to and can be used in the portable computer of FIG. 2. For example, a LCD 19 of a notebook computer can include a light-emitting element 190 such as a CCFL (Cold Cathode Fluorescent Lamp) disposed at an upper or lower side or a predetermined position of the LCD 19.

The notebook computer can further include a battery 31 or an AC adapter 32, a power supply 30 for supplying power from the battery or the AC adapter after changing the power to a designated voltage, and an inverter 33 for applying the designated voltage being applied via the power supply 30 to the light-emitting element 190, by high-speed switching under a Pulse Width Modulation signal. When a user increases or decreases the brightness level of the LCD 19 using the keyboard 21, a micom 20 can vary the Pulse Width Modulation signal applied to the inverter 33 in order to adjust the brightness level of the LCD.

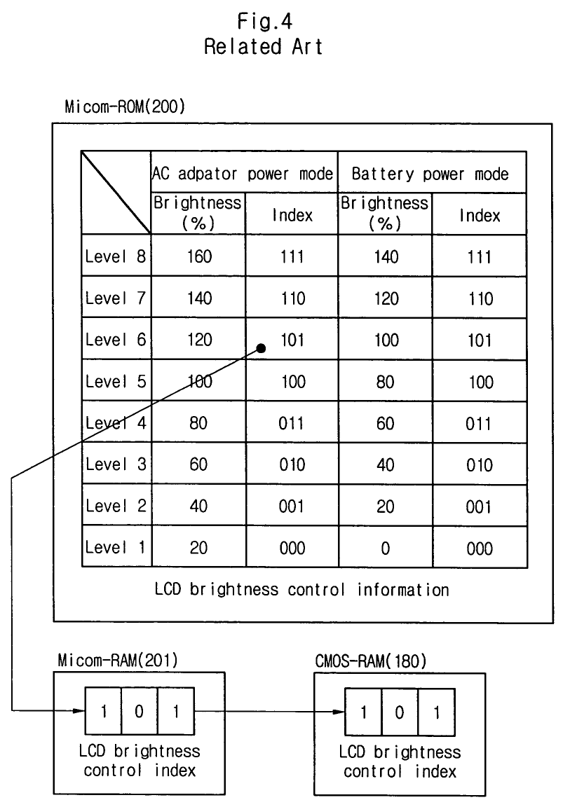

As shown in FIG. 4, inside the micom is a ROM 200 in which LCD brightness control information that is adjustable in an AC adapter power mode or a battery power mode, respectively, is stored per level. For instance, the LCD brightness control information includes brightness information (in %) and index information from Level 1 to Level 8 in the AC adapter power mode as well as in the battery power mode.

As shown in FIG. 4, the brightness in the AC adapter power mode ranges from 20% to 160% (20% being lowest, 160% being highest), and increases and decreases by 20% for each level. On the other hand, the brightness in the battery power mode ranges from 0% to 140% (0% being lowest, 140% being highest), and increases and decreases by 20% for each level.

Meanwhile, the index information is like an ID code corresponding to each level regardless of the AC adapter power mode or the battery power mode. In other words, each level has its own code (e.g., the index code for Level 1 is ‘000’ and the index code for Level 8 is ‘111’). The index information is stored with the brightness information for each level since they are closely associated with each other.

Therefore, when the user increases or decreases the brightness level of the LCD 19 using the keyboard, the micom 20 confirms which power (i.e., the AC adapter or the battery) is used in the power supply 30, and refers to the LCD brightness control information stored in the internal ROM 200 to read the kind of power currently being used and the index information corresponding to an increased/decreased brightness level by the user. For example, suppose that the power currently being used is the AC adapter power, and the user designated the LCD brightness level to ‘level 6’. In this case, the micom 20 reads the ‘101’ index information associated with the ‘120%’ brightness information, and temporarily stores it in the internal RAM 201 of the micom 20. Afterwards, the micom 20 varies the Pulse Width Modulation signal that is applied to the inverter 33 to a Pulse Width Modulation signal corresponding to the index ‘101’, and adjusts the brightness level of the LCD to ‘120%’.

The ‘101’ index information is then stored in the CMOS-RAM 180 via a system BIOS. If the system power is turned on after being turned off, the system BIOS reads the ‘101’ index information stored in the CMOS-RAM 180, and transfers the information to the micom 20. The transferred ‘101’ index information is recorded in the RAM 201 of the micom 20. In this way, even though the system power is turned on after being turned off, the previous brightness of the LCD before the system is turned off, namely 120% brightness, can be maintained.

However, only single index information is recorded, i.e., stored in the RAM 201 of the micom 20 and the CMOS-RAM 180. Therefore, if the kind of power is changed from the AC adapter power to the battery power when the system power is turned on after being turned off, the index information of the AC adapter indicates the brightness information of the battery power mode, and thus the LCD brightness level is adjusted from 120% to 100%. In such a case, the user should adjust the LCD brightness again.

Also, when the user sets the LCD brightness level to 120% in the battery power mode, and then changes the power mode to the AC adapter power, the ‘110’ index information indicating the 120% LCD brightness is used without change. As a result, the LCD brightness is automatically adjusted to 140% in the AC adapter mode. Hence, the user should readjust the LCD brightness.

Likewise, when the user sets the LCD brightness to 120% in the AC adapter mode, and then separates the AC adapter, the index information e.g., the ‘101’ index information indicating the 120% LCD brightness in the AC adapter power mode is used without change. As a result, the LCD brightness is adjusted from 120% to 100% in the battery power mode. Therefore, the user should readjust the LCD brightness.

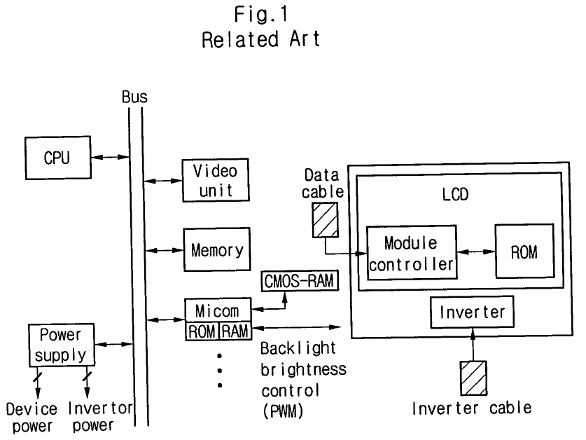

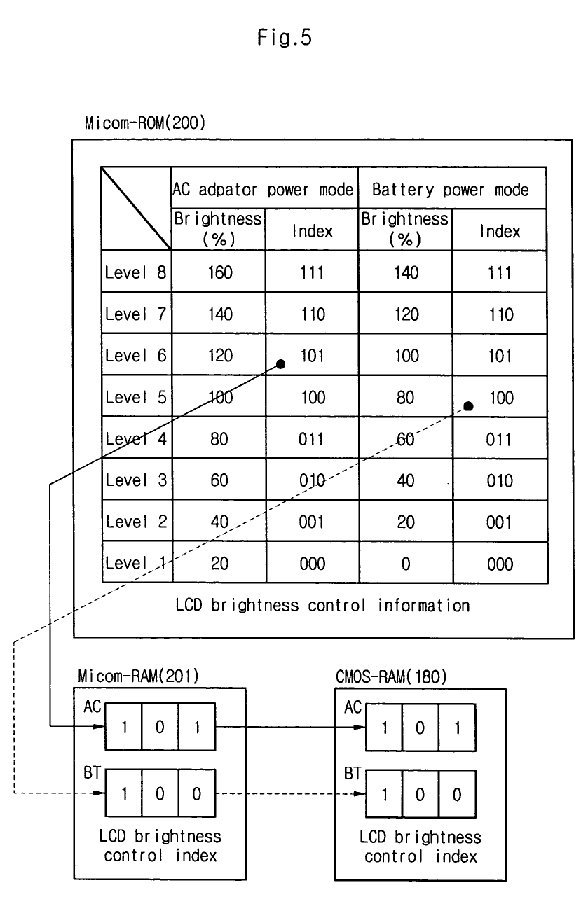

Embodiments of methods and apparatus configured to adjust the brightness level of a display such as an LCD, for example, used in a portable personal computer according to the present invention will now be described. FIG. 5 is a diagram illustrating an embodiment of a display brightness control information that can be used in a brightness level controlling apparatus and methods thereof. The brightness control information can be applied to and will be described ,with reference to the portable personal computers shown in FIGS. 1-3. However, the present invention is not intended to be so limited. As shown in FIG. 5, the brightness control information (e.g., stored in the internal ROM 200 of the micom 20) can store adjustable LCD brightness control information for each level in a plurality of power modes such as the AC adapter power mode and in the battery power mode, respectively.

The LCD brightness control information can include brightness (e.g., in %) and index information from Level 1 to Level 8 both in the AC adapter power mode and in the battery power mode. As shown in FIG. 5, the brightness in the AC adapter power mode can range from 20% to 160% (e.g., 20% being lowest, 160% being highest), and can increase and decrease by 20% for each level. On the other hand, the brightness in the battery power mode ranges from 0% to 140% (e.g., 0% being lowest, 140% being highest), and increases and decreases by 20% for each level. However, the present invention is not intended to be so limited as other low or high range limits and other prescribed increase and decrease amounts can be used. For example, prescribed increase and decrease amounts can be variable.

The index information is preferably like an ID code corresponding to each level, for each of a plurality of power mode types. Power mode types can include the AC adapter power mode, the battery power mode, etc. In other words, each level can leave its own code (e.g. the index code for level 1 is ‘000’ and the index code for level 8 is ‘111’). The index information can be stored with the brightness information for each level.

Therefore, when the user increases or decreases the brightness level of the LCD 19 using the keyboard, the micom 20 confirms which power is used in the power supply 30, (e.g., the AC adapter or the battery), and refers to the LCD brightness control information stored in the internal ROM 200. Thus, the micom 20 can read the kind of power currently being used and the index information corresponding to an increased/decreased brightness level by the user.

The readout index information can be temporarily stored in the RAM 210 inside the micom 20, and then CMOS-RAM 180 via a system BIOS. If the system power is turned on after being turned off, the system BIOS preferably reads the index information stored in the CMOS-RAM 180, and transfers the information to the micom 20. As shown in FIG. 5, the index information stored in the micom RAM 201 and the CMOS-RAM 180 are stored in both the AC adapter power mode and in the battery power mode, respectively.

Accordingly, if the power mode of the portable personal computer is changed from the AC adapter power mode to the battery power mode, the user can adjust the brightness level of the LCD with reference to the index information of the battery power mode. Preferably, the index information is distinguishably stored in the micom RAM or in the CMOS-RAM. On the contrary, if the power mode of the portable personal computer is changed from the battery power mode to the AC adapter power mode, the user can adjust the brightness level of the LCD with reference to the index information of the AC adapter power mode, and the index information for the AC adaptor power mode is separately stored in the micom RAM or in the CMOS-RAM.

In addition, when the system power of the portable personal computer is turned on after being turned off, the type of power currently being used in the power supply can be identified or confirmed. By referring to index information stored in the CMOS-RAM in either the AC adapter power mode or in the battery power mode according to embodiments of the present invention, the brightness level of the LCD is adjusted.

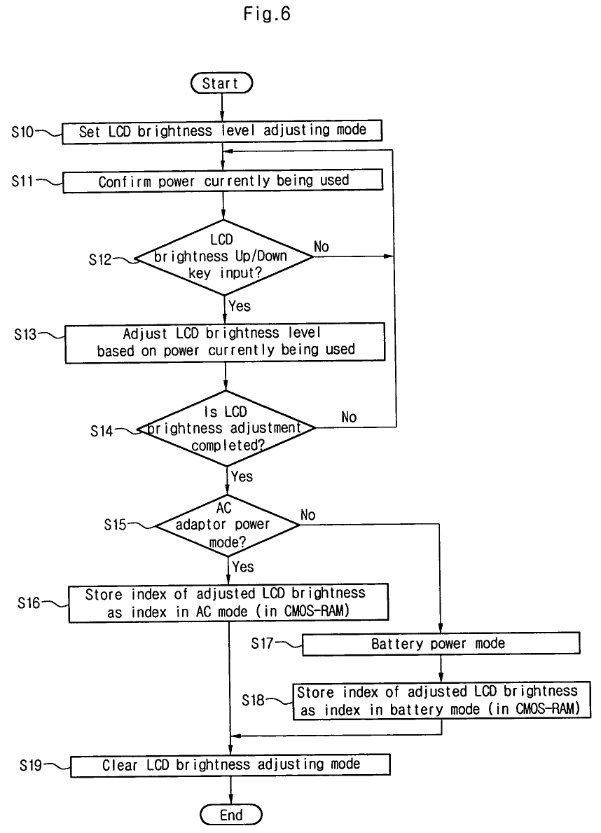

FIG. 6 is a flow chart that shows a method for adjusting the brightness level of a LCD in a portable personal computer according to an embodiment of the present invention. The method shown in FIG. 6 can be applied to and will be described using the portable computer shown in FIG. 3. However, the present invention is not intended to be so limited.

As shown in FIG. 6, after a process starts, a LCD brightness level adjustment mode can be set by the user's request or the like (block S10). Then, the type of power, either the AC adapter power, the battery power or the like, that is currently being used in the power supply 30 can be determined (block S11).

If it is determined that the brightness level of the LCD is adjusted, for example, by the user depressing a brightness up/down key (block S12), the micom 20, referring to the type of power currently being used, can adjust the brightness level of the LCD (block S13). For instance, if the power being used is the AC adapter power and the user designates the brightness level of the LCD as ‘level 6’, the micom 20 reads ‘101’ index information associated with ‘120%’ brightness corresponding to the level 6, and temporarily stores the information in the RAM 201 inside the micom 20. The ‘101’ index information, as shown in FIG. 5, can be stored as the index information in the AC adapter power mode, being distinctive from the index information in the battery power mode or additional power modes. Afterwards, a Pulse Width Modulation (PWM signal applied to the inverter 33 is preferably changed to a PWM signal corresponding to the ‘101’ index information, whereby the brightness of the LCD is adjusted to ‘120%’.

Once the LCD brightness level adjustment is complete (block S14), the micom 20 can confirm if the power currently being used is the AC adapter power (block S15). Preferably, the temporarily stored ‘101’ index information in the micom RAM 201 is then stored in the CMOS-RAM 180 via the system BIOS (block S16). The ‘101’ index information stored in the CMOS-RAM 180 is stored as the index information in the AC adaptor power mode (e.g., as shown in FIG. 5), apart from the index information in the battery power mode being stored in the CMOS-RAM 180.

On the other hand, the power mode can change, for example, the user can designate the brightness level of the LCD such as ‘level 5’, while the power currently being used is in the battery power mode (block S15). Preferably, the micom 20, as shown in FIG. 5, reads the ‘100’ index information linked to the ‘80%’ brightness, and can separately store the readout information in the RAM 201 inside the micom 20 as the index information in the battery power mode (block S17), and then, in the CMOS-RAM 180 as the index information in the battery power mode (block S18).

Then, the LCD brightness level adjusting mode can be cleared (block S19). Further, whether the system power is turned on after being turned off, or whether the power being used is changed can be preferably continuously monitored.

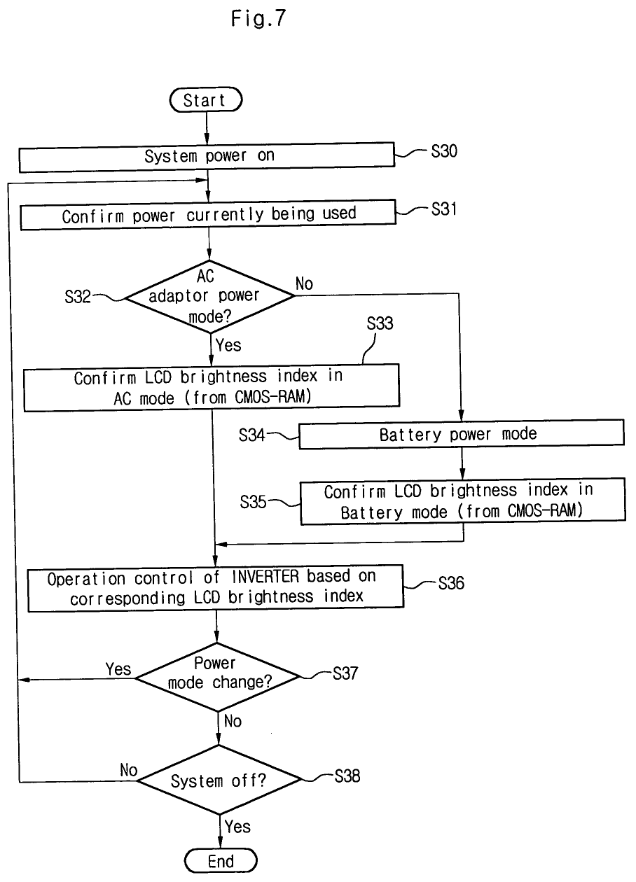

FIG. 7 is a flow chart that shows a method for adjusting the brightness level of a LCD in a portable personal computer according to another embodiment of the present invention. The method shown in FIG. 7 can be applied to and will be described using the portable computer shown in FIG. 3. However, the present invention is not intended to be so limited.

As shown in FIG. 7, after a process starts the system power mode of the portable personal computer is switched from a power off mode to a power on mode (block S30). Then, the micom 20 can confirm whether the power currently being used is an AC adopter power or a battery power (block S31).

If it is determined that the AC adaptor power is currently being used (block S32), the micom 20 preferably reads the index information for the AC adaptor power mode out of the index information stored in the CMOS-RAM 180 corresponding to a selected level, such as the ‘101’ index information in the AC adaptor power mode and the ‘100’ index information in the battery power mode as shown in FIG. 5 for level ‘6’ (block S33). The micom 20 can temporarily store the ‘101’ index information in the AC adaptor power mode in the micom RAM 201, and preferably varies a pulse Width Modulation (PWM) signal applied to the inverter 33 to a PWM signal corresponding to the ‘101’ index information to adjust the brightness of the LCD to ‘120%’ (block S36).

Alternatively, if the power currently being used is the battery power (block S34), the micom 20 can read the ‘100’ index information in the battery power mode out of the ‘101’ index information in the AC adaptor power mode and the ‘100’ index information in the battery power mode being stored in the CMOS-RAM 180 (block S35). The micom 20 can temporarily store the ‘100’ index information in the battery power mode in the Micom RAM 201, and preferably varies a pulse Width Modulation (PWM) signal applied to the inverter 33 to a PWM signal corresponding to the ‘100’ index information to adjust the brightness of the LCD to ‘80%’ (block S36).

In addition, if it is determined that the power being used is changed after completion of adjusting the LCD brightness level (block S37), the micom 20 can read the ‘100’ index information in the changed power mode and based on this information, adjust the brightness of the LCD. For example, if the user separates the AC adaptor being used, causing the power mode to be automatically turned to the battery power mode, the micom 20 can read the ‘100’ index information in the battery power mode (e.g., changed power mode) and adjust the brightness of the LCD to ‘80%’ based on this information.

On the other hand, if the user inserts the AC adaptor while the battery power is being used, which causes the power mode to be automatically turned to the AC adaptor power mode, the micom 20 can read the ‘101’ index information in the AC adaptor power mode (e.g., changed power mode) and based on this information, adjust the brightness of the LCD to ‘120%’.

As described above, before the portable personal computer system is turned off or before the power being used is switched, the user can adjust brightness level of the LCD, which has been arbitrarily set, independently and individually according to the AC adaptor power and the battery power.

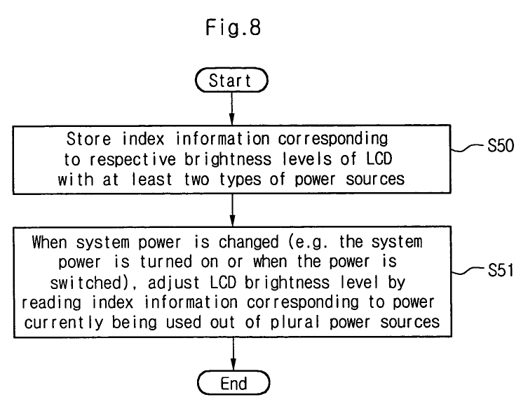

FIG. 8 is a flow chart that shows an embodiment of a method for controlling the brightness level of a LCD according to the present invention. As shown in FIG. 8, after a process starts, index information corresponding to respective brightness levels of the LCD with at least two types (e.g., plurality) of power sources can be stored (block S50).

Preferably, index information values are determined with reference to experimental values or Data Book. However, the present invention is not intended to be so limited.

When the system power is changed (e.g. when the system power is turned on or when the power is switched), index information corresponding to a power to be currently used out of the plurality of power sources is used to adjust the LCD brightness level (block S51). For example, the index information can be read by the micom 20. The index information can contain information, for example, similar to the information shown in FIG. 5.

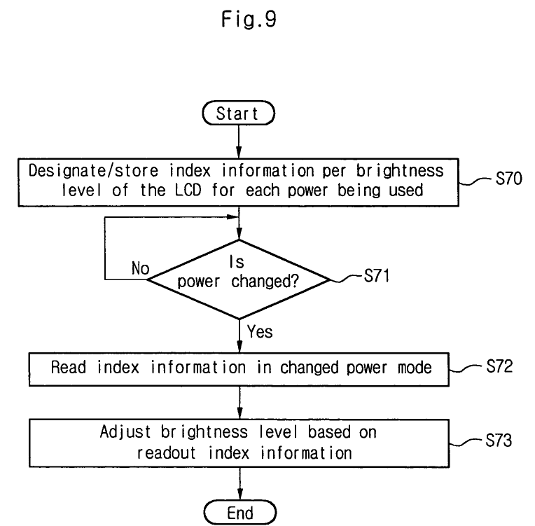

FIG. 9 is a flow chart that shows an embodiment of a brightness control method responsive to the change of power being used according to the present invention. As shown in FIG. 9, after a process starts, index information per brightness level or levels of the LCD for each power configured to be or being used can be set and stored (block S70). The index information per brightness level can take the form, for example, of the information shown in FIG. 5.

Then, it is determined whether the power being used has been changed (block S71). When it is determined that the power being used has been changed (block S71), information on the changed power can be determined (e.g., read out of a memory) (block S72). The brightness level of the LCD is preferably adjusted based on the readout index information (block S73).

As described above, embodiments of methods and apparatus for controlling a brightness of a display have various advantages. Embodiments of a method for controlling brightness levels of a display such as an LCD can separately store values for each of a plurality of brightness levels for two or more power modes. Thus, independent brightness level controls can be determined and operated for the two or more power modes, for example, when the power mode changes, system power is restarted or a brightness level changes. The LCD can be used in a portable computer.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structures.

What is claimed is:

1. A method for adjusting a brightness level of a display used in a portable computer system, the method comprising:
separately providing brightness control information for a plurality of brightness levels for each of at least two power mode types;
confirming a type of power mode currently being used out of said at least two power mode types; and
controlling the brightness level of the display by using corresponding brightness control information on the confirmed power mode.

2. The method according to claim 1, comprising adjusting the brightness level of a LCD using an input device, wherein the type of power mode currently being used includes at least one of an AC adaptor mode and a supplementary battery mode.

3. The method according to claim 1, wherein when power of the portable computer system is switched to a power on mode from a power off mode, the type of power mode currently being used includes at least one of an AC adaptor mode and a supplementary battery mode.

4. The method according to claim 1, wherein when the power mode type currently being used in the portable computer system is changed to a different power mode type, the changed power mode type includes at least one of an AC adaptor mode and a supplementary battery mode.

5. The method according to claim 1, wherein when a power supply being confirmed is a supplementary battery, the brightness level of the display is adjusted by using an index information corresponding to the brightness levels in a battery power mode.

6. The method according to claim 5, wherein when a power supply being confirmed is an AC adaptor, the brightness level of the display is adjusted by using an index information corresponding to the brightness levels in an AC adaptor power mode.

7. The method according to claim 6, wherein the index information corresponding to the brightness levels in the AC adaptor power mode and the index information corresponding to the brightness levels in the battery power mode are independent and respectively stored in a storage device.

8. The method according to claim 7, wherein the index information corresponding to the brightness levels in the AC adaptor power mode and the index information corresponding to the brightness levels in the battery power mode are separately stored in a microcomputer memory of the personal computer system and in a system initialization RAM.

9. The method according to claim 1, wherein when a power supply being confirmed is an AC adaptor, the brightness level of the display is adjusted by using an index information corresponding to the brightness levels in an AC adaptor power mode.

10. A method, comprising:
determining a type of power supply currently being used among a plurality of power supplies in a computer system when a brightness level of a display is adjusted;
selecting a brightness level information corresponding to the determined power supply type among brightness level information of the adjusted brightness level of the display for each of the plurality of power supplies and reading an index information corresponding to the selected brightness level information; and
driving the adjusted brightness level of the display based on the readout index information, and independently storing the index information according to the type of power supply.

11. The method according to claim 10, wherein the index information is stored in a memory, and at least one of an index information corresponding to an adjusted brightness level in an AC adaptor power mode and an index information corresponding to an adjusted brightness level in a battery power mode is separately stored in the memory.

12. The method according to claim 10, further comprising:
changing from a first power supply being an AC adaptor to a second power supply being a battery, wherein the driving the adjusted brightness level of the display comprises referring to an index information in a battery power mode, and wherein the index information is separately stored in a memory.

13. The method according to claim 12, comprising:
changing from the battery to the AC adaptor, wherein the driving the adjusted brightness level of the display comprises referring to an index information in an AC adaptor power mode, and wherein the index information is separately stored in the memory.

14. The method according to claim 10, comprising:
turning on power of the computer system after the power was turned off, wherein the driving the adjusted brightness level of the display comprises confirming the type of power supply currently being used, and reading out of a memory an index information in an AC adaptor power mode or in a battery power mode.

15. The method according to claim 10, wherein the brightness level of the display is adjusted automatically, periodically or using an input device by a user.

16. A method for adjusting a brightness level of a display, the method comprising:
independently storing index information corresponding a brightness level of the display in at least two different power modes; and
adjusting a brightness of the display using information on a current power mode being used and the stored index information for the brightness level of the current power mode when the power mode is changed.

17. The method according to claim 16, wherein the independently storing comprises designating and separately storing brightness information in a plurality of brightness levels for each of the two different power modes.

18. The method of claim 16, comprising adjusting the brightness level of a LCD using an input device, wherein the type of power mode currently being used includes at least one of an AC adaptor mode and a supplementary battery mode.

19. The method of claim 18, wherein a brightness level in the AC adaptor mode is set different than a brightness level in the supplementary battery mode.

20. An apparatus that controls an inverter pulse width modulation (PWM) frequency of a liquid crystal display (LCD) in a portable computer, comprising:
a storage device configured to separately provide LCD brightness level information for a plurality of brightness levels for each of at least two power mode types;
an inverter configured to supply a voltage to the LCD; and
control means for controlling a PWM frequency of the inverter in accordance with a designated brightness level, a current power supply mode and the corresponding LCD brightness level information for the current power supply mode.

21. The apparatus of claim 20, wherein the LCD brightness level information includes index information.
